(19) United States
(12) Patent Application Publication
(10) Pub. No.: US 2003/0159146 A1
(43) Pub. Date: Aug. 21, 2003

(54) Remote controller and broadcasting receiver having electronic program guide (epu) function and service system and method using same

(76) Inventor: Deok-Woo Kim, Seoul (KR)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/312,410

(22) PCT Filed: Jun. 28, 2001
(86) PCT No.: PCT/KR01/01119

(30) Foreign Application Priority Data
Jun. 29, 2000 (KR) 2000/36611
Jun. 26, 2001 (FR) 2001/36545

(51) Int. Cl. G06F 3/00; H04N 5/445; G06F 13/00; H04N 7/173; H04N 7/16; H04N 7/00; H04N 11/00

(52) U.S. Cl. 725/46; 725/50; 725/133; 725/141; 348/552

(57) ABSTRACT

Disclosed is a remote controller and broadcasting receiver having an EPU function and service system and method using the same. A program receiver receives broadcasting signals in wire or wireless manners and extracts broadcasting program information. A signal processor controls the extraction of the broadcasting program information by the program receiver, decodes the extracted broadcasting program information and controls to store the same in a memory. An input and output unit inputs and outputs the broadcasting program information, outputs a control signal for selecting broadcasting channels to the signal processor according to a user's manipulations, receives broadcasting program information including at least one of a public broadcasting channel, a

### BACKGROUND OF THE INVENTION

(a) Field of the Invention

The present invention relates to a remote controller having an electronic program guide (EPG) function, a broadcasting receiver set, and a service system and method using the same. More specifically, the present invention relates to a remote controller having an EPG function, a broadcasting receiver set, and a service system and method using the same for users to selectively view desired programs using program information under a multi-channel circumstance.

(b) Description of the Related Art

In general, an EPG uses independent channels or carriers to provide program guide information, and it has been widely used for decades in many multi-channel broadcasting countries such as the US and Europe. The Korea Broadcasting Station (KBS) also realized the EPG in the KBPS method using carriers in 1996, but in order to receive guide information in the KBPS method, new televisions having a guide function must be used.

Broadcasts viewable by current televisions are categorized as analog signal broadcast and the digital signal broadcasts according to broadcasting methods. It is expected that the analog broadcasts will be switched to digital broadcasts in the future. That is, broadcasting stations such as KBS or Education Broadcasting, Station (EBS) are currently testing digital broadcasting via a Moogoongwha satellite, and terrestrial digital broadcasting service will be started soon after a predetermined period of test broadcasting, and accordingly, the number of channels will be increased to more than 200.

In addition, the broadcasts are categorized as satellite broadcasts, cable broadcasts, and terrestrial broadcasts, according to transmission media.

Cable broadcasting provides specialized contents through about 40 channels, and the number of channels can be greatly increased depending on the service categories. Satellite broadcasting currently does root have many satellites, and hence it does not provide various viewable satellite broadcasting programs. However, since nations use satellite broadcasting to propagate programs worldwide, the number of viewable satellite broadcasts will be gradually increased.

Since the number of viewable channels is increasing because of switching to the above-noted multi-channel environments, more effective provision of viewable broadcast information to the viewers from the respective channels is required. Present broadcast information is transferred, to the viewers through guides via media such as newspapers, program guides via specialized channels, or Internet guides in connection with Internet broadcasting, and the transferred information is utilized only for simple program information purposes.

Hence, since information on hundreds of broadcasting channels cannot be effectively provided to the viewers, and information more meaningful than program information cannot be provided under the present methods, methods and systems for remedying defects of the existing methods are required to enable users to easily select desired broadcast programs when the channels are increased.

### SUMMARY OF THE INVENTION

It is an object of the present invention to provide an EPG remote controller for conveniently selecting channels of a broadcast program according to a viewer's interests in connection or disconnection with a television and its related devices under a multi-channel circumstance.

It is another object of the present invention to provide an EPG service system using an EPG remote controller.

It is still another object of the present invention to provide an EPG remote controller service method using the EPG remote controller.

It is further another object of the present invention to provide a broadcasting receiver set having an EPG function for a viewer to conveniently select desired channels of broadcast programs under multi-channel environments.

In one aspect, of, the present invention, an EPG remote controller for wire or wirelessly downloading broadcasting program information including at least one of broadcasting channel from among at least one public broadcasting channel, at least one satellite broadcasting channel and at least one cable television channel, storing the same, and selecting a broadcasting channel based on the stored information, comprises: a memory unit for storing information for selecting broadcasting channels; a signal sender for outputting signals for changing the broadcasting channels according to a user's manipulation; a program receiver for wire or wirelessly receiving broadcasting signals, and extracting broadcast program information; a signal processor for controlling the program receiver's extraction operation of the broadcast program information, decoding the extracted broadcast program information and controlling the decoded broadcast program information to be stored in the memory; and an input/output unit for inputting/outputting broadcast program signals according to the user's manipulation, and outputting control signals for selecting broadcasting channels to the signal processor.

In another aspect of the present invention, an EPG service method using an EPG remote controller comprises: (a) assigning categories of interests broadcast programs from programs including at least one broadcasting channel from among at least one public broadcasting channel, at least one satellite broadcasting channel and at least one cable television channel, and requesting program information for channel selection; and (b) downloading channel selection information by using information including the assigned program categories, and selecting a channel by using the downloaded channel selection information.

In still another aspect of the present invention, an EPG service system using, an EPG remote controller, comprises: an EPG information provider for storing program planning information including at least one broadcasting channel of at least one public broadcasting channel, at least one satellite broadcasting channel and at least one cable television channel and guide information; and an EPG remote controller for inputting personal information including an EPG remote controller number, an ID and interests of broadcast programs, assigning a desired broadcast program category, requesting channel selection information from the EPG information provider, downloading its response information through a wireless communication network or a network backbone network, and manipulating a channel of a program based on the downloaded channel selection information.

### BRIEF DESCRIPTION OF THE DRAWINGS

The accompanying drawings, which are incorporated in and constitute a part of the specification, illustrate an embodiment of the invention, and, together with the description, serve, to explain the principles of the invention:

FIG. 1 shows a schematic diagram of an EPG service-providing system according to a first preferred embodiment of the present invention;

FIG. 2 shows a screenshot of an Internet homepage for providing the EPG service according to a first preferred embodiment of the present invention;

FIG. 3 shows exemplified EPG remote controllers according to a first preferred embodiment of the present invention;

FIG. 4 shows a block diagram of an EPG remote controller according to a first preferred embodiment of the present invention;

FIG. 5 shows signal configurations transmitted to the EPG remote controller according to a first preferred embodiment of the present invention;

FIG. 6 shows a flowchart for an operation of the EPG remote controller according to a first preferred embodiment of the present invention;

FIG. 7 shows a flowchart for an operation of the EPG remote controller according to a second preferred embodiment of the present invention,

FIG. 8 shows a schematic diagram of an EPG service-providing system according to a second preferred embodiment of the present invention; and

FIG. 9 shows a broadcasting receiver set having an EPG function.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

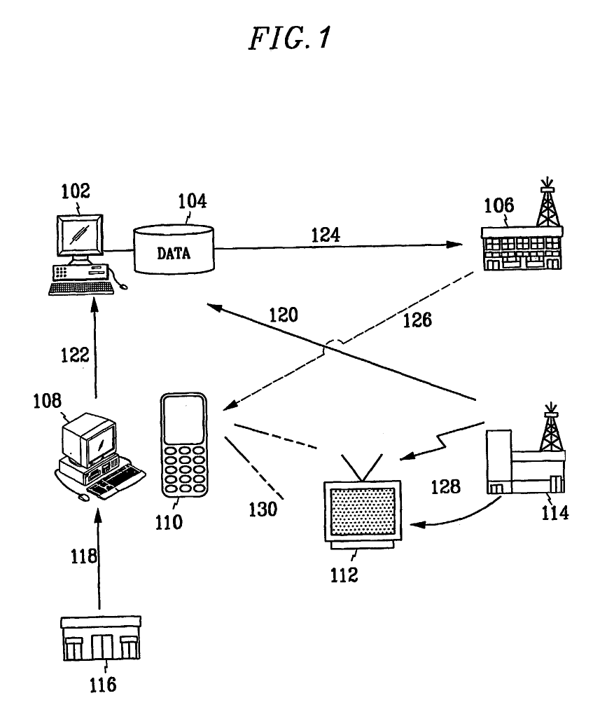

FIG. 1 shows an EPG service-providing system using an EPG remote controller according to a first preferred embodiment of the present invention.

As shown, the system comprises Internet service providers (ISP) 102 and 104, a communication service provider 106, a broadcasting station 114 and user devices 108, 110 and 112.

A user of the EPG remote controller 110 accesses an EPG service homepage provided by the ISP 102, and inputs personal information such as, an EPG remote controller number, a user identification (ID) and program's interests in 122.

The ISP 102 stores users' personal information, compares it with program information provided by the broadcasting station 114, classifies program information fitting the user's interests for each user, and stores it. The ISP 102 transmits information on the classified interests program to the communication service provider 106 for each predetermined time according to the user's EPG remote controller number, and the communication service provider 106 transmits the same to respective users through a communication network in 126. Here, when wirelessly receiving broadcast program information, the communication service provider 106 can transmit it on a network managed by a personal communication service (PCS) service provider or a pager service provider, and when receiving the broadcast program information through a wire method such as an Internet personal computer (PC), the communication service provider 106 can receive it via the lSP.

The user 108 reads desired program information from among various channels through the EPG remote controller 110 with a liquid crystal display (LCD) screen attached (which can be omitted if needed), and conveniently selects a desired channel in 130.

To transmit broadcast program information to the EPG remote controller on the basis of the concept shown in FIG. 1, a pager can be used, for example. That is, the ISP classifies user information received via the ISP's homepage and broadcast program information for each user, and transmits the information classified for each user to the communication service provider according to each user's remote controller number (or a pager number when using the pager) so as to wirelessly transmit each user's broadcast program information to each remote controller.

In the above-described preferred embodiment, a skilled person can obviously use a frequency modulation, data radio channel (FM DARC) method or a wireless data network as, well as the pager network. In particular, when receiving broadcast program information through the wireless data network, the skilled person can obviously implement the EPG remote controller by modifying a mobile phone equipped with an infrared ray communication module or a Bluetooth communication module, or by amending, hardware or software of a personal digital-assistant (PDA).

As a second preferred embodiment, instead of classifying program interest information according to user registration and each user's interest field registration on the EPG service homepage, the ISP transmits all the broadcasting station's program information to the user, and the EPG remote controller classifies the program information according to the user's interests so that the user may select a desired channel. In this case, each user inputs a desired interest program according to the user registration and the interest field registration through the EPG remote controller possessed by the user, the EPG remote controller classifies each user's broadcast programs based on the program information received through the wireless communication network, and the user operates the remote controller to automatically select a channel according to the classified broadcast program information.

In the above-described second preferred embodiment, a skilled person can obviously use an FM DARC method or a wireless data network as well as the pager network. In particular, when receiving broadcast program information through the wireless data network, the skilled person can obviously implement the EPG remote controller by using a mobile phone or a PDA equipped with an infrared ray communication module or a Bluetooth communication module.

The EPG service can be performed in the 700-telephone number service form using wire and wireless telephones. That is, each user inputs the user's remote controller information and interest program information through the paid 700-telephone number service so that the EPG service provider can receive user information, and the subsequent process is identical or similar to the previous description.

Also, in the second preferred embodiment, the user can access the EPG service provider's Internet site through, a wireless terminal such as a mobile phone or a PDA. That is, in this case, the user can wirelessly access the EPG service provider's Internet site and input the user's remote controller information and interest program information.

The EPG remote controller according to the preferred embodiment of the present invention has a merit of using the remote control method of the existing TVs, VCRs and set-top boxes without changing the existing analog TV sets.

Also, the user can receive broadcast program information from the TV (analog or digital), VCR, set-top box (cable, satellite or digital set-top box), PC or a home server through radio waves or the wire network, and transmit the broadcast program information to the remote controller via the wireless communication device such as the infrared ray device or the Bluetooth.

In this case, the above-noted EPG remote controller can be implemented in the identical manner of the first and second preferred embodiments, and in the case of the analog TV set, the broadcast program information is primarily transmitted using, the conventional method such as the KBPS method, and secondarily transmitted to the remote controller through the infrared ray or the Bluetooth method.

The skilled person knows that the broadcast program information includes wire broadcasting service providers' broadcast program information as well as that of existing terrestrial wave broadcasting, satellite broadcasting and cable broadcasting.

In the above-described cases, the wire broadcasting service providers respectively obtain cable broadcasting service management rights for respective local areas to be general wire broadcasting service providers, or transmit the terrestrial broadcasts, their recorded broadcasts, cable broadcasts or satellite broadcasts through channels individually selected by the wire broadcasting service providers together with a service for solving reception problems for the respective local areas caused by geographic and other physical obstructions, like tall buildings or high mountains Therefore, in this case, as a preferred embodiment, the user who requests the EPG service registers the user's address (e.g., a postal code) at which the user's TV set is located, and a message that the user is a registered wire broadcasting viewer together with the existing user information and the EPG service provider receives wire broadcasting program information (optionally together with the satellite broadcasting program information and the cable broadcasting program information according to the preferred embodiments) from the wire broadcasting service providers at the respective local areas, and transmits the same to the EPG remote controller through the wireless communication network. Accordingly, when watching the broadcasts via the wire broadcasting service provider, the viewer utilizes address information (e.g., the postal code) and the EPG remote controller number to watch desired broadcasts according to the viewer's interests.

In the above-noted modified embodiments, marginal modifications or additions can be obviously included in the preferred embodiment shown in FIG. 1.

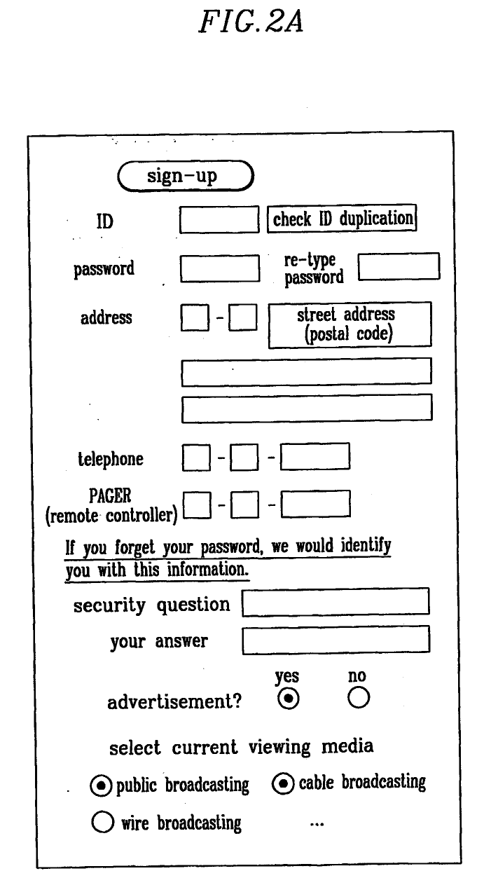

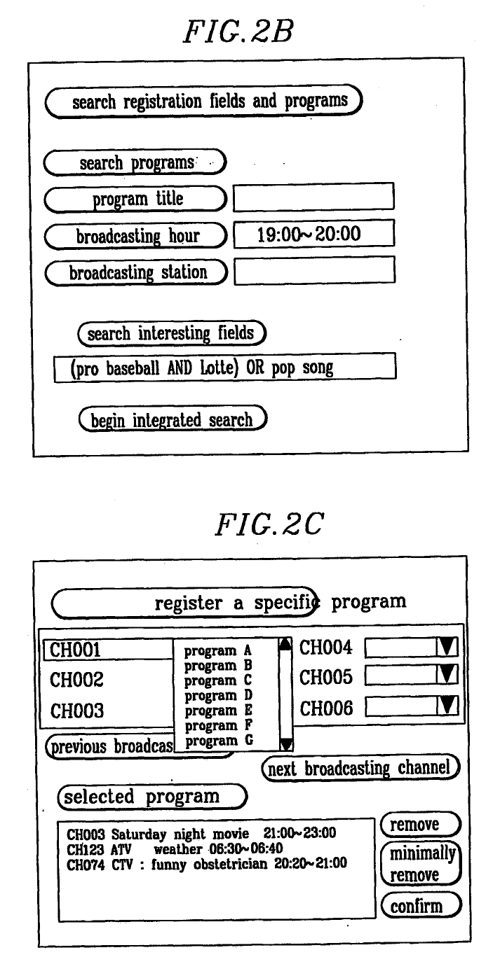

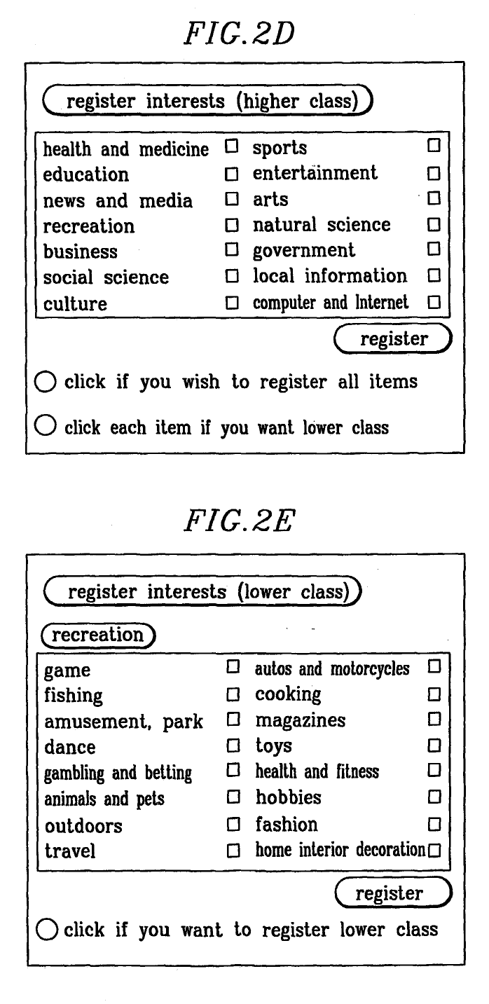

FIG. 2 shows exemplified Internet homepages for providing the EPG service according to a preferred embodiment of the present invention.

In the first preferred embodiment of the present invention, the EPG remote controller displays programs selected according to the user's interests, and not all broadcast programs, and hence a step for registering the user's interest fields is required before the step of transmitting programs, which is shown in FIG. 2.

Referring to a sign-up screen of FIG. 2(a), the user inputs personal information such as the user's ID, name, password, address, telephone number, EPG remote controller number (e.g., a pager number), whether to view advertisements, and viewing media selection. In this case, the ID and the name are used to identify the respective users when many persons attempt to obtain program information using a single EPG remote controller. When the users modify information (e.g., personal information, interests and interest programs) registered via the homepage for receiving the EPG service, the password prevents the information from being falsified by malicious third persons.

The communication service provider uses the EPG remote controller number (or the pager number) to transmit the respective users' interest broadcast programs provided by the ISP. In this instance, if many users use a single EPG remote controller the communication service provider transmits many users interest broadcast program information.

Also, when a user selects to view the advertisements, advertisements matched with the user's interests and shopping programs are transmitted to the user. That is, as an example, when the user selects to view the advertisements, service providers can manage the service by providing benefits through individual service fees, and when an advertisement that fits the viewer's interests is broadcast while the channel is being switched, a channel for broadcasting the advertisement is designed to be selected while the channel is switched from a previous channel to a next one. Therefore, in the case of the EPG service according to the present invention, since the advertisements are also selected according to the user's interests, the advertisements' target marketing is possible, and the respective users' interest information transmitted to the EPG service provider can be used as high value-added information through a data mining process.

Also, according to the present invention, when the user inputs an address in the input window as shown in FIG. 2(a), the ISP can check a broadcasting channel from the user's residence place and viewing media, and accordingly, as described above, a service for providing program guides that fit users' interests can be implemented for the broadcasting services managed by the public broadcasting, terrestrial broadcasting, satellite broadcasting, cable broadcasting and wire broadcasting service providers.

Also, the EPG remote controller can be used for other purposes in addition to the broadcast program guide service. For example, the EPG remote controller can be implemented in a local information-receiving terminal, and in this case, the ISP can catch the user's area through the user's address or postal code and provide local information fitting the user.

Next, a method for selecting information of desired programs fitting the user's interests from among hundreds of channels and dozens of programs for each channel can be categorized in two methods.

One of them is to directly assign a specific program as shown in FIG. 2(b). The user searches programs by keywords, broadcasting time, broadcasting stations or combinations of these data through a search window provided by the EPG service homepage, and registers the specific program. Or, as shown in FIG. 2(c), the user directly selects desired programs on a specific program registration screen that displays a list of all programs, and registers them.

In a different method, as shown in FIGS. 2(d) and 2(e), when the user provides the user's trends and interests to the ISP, the ISP selects programs fitting the user's trends and interests, and provides them. One embodiment of this method is that the user selects the user's desired, categories from an interests list provided by the ISP and registers them, and the ISP selects the programs matched with the user's interests from the program information provided by the broadcasting station and provides them to the user.

If needed, the service may be provided such that the ISP asks the user some questions, analyzes the user's trends and interests through the user's answers, and provides a program that fits the user's trends and interests.

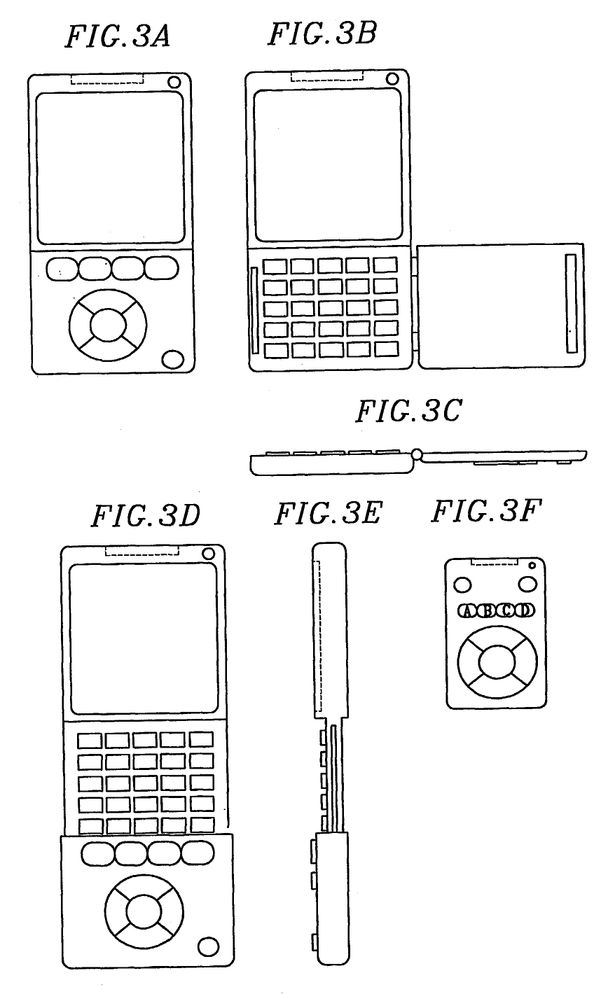

FIG. 3 shows an exemplified EPG remote controller according to a preferred embodiment of the present invention.

As shown, the EPG remote controller has an optional LCD window for outputting program information. If necessary, the LCD can be omitted.

The EPG remote controller includes a plurality of keys for switching channels, adjusting volume, turning on/off televisions, VCRs and set-top boxes, and performing other functions. An infrared ray emitter for transmitting signals for controlling the television, the VCR and the set-top box, and a light emitting diode (LED) for displaying a battery's charging states are provided on the front side of the EPG remote controller.

As shown in FIGS. 3(b) to 3(d), the EPG; remote controller can obviously adopt the existing remote controller type or a covering or sliding type for providing more intelligent EPG services.

When more keys such as number keys are required for the EPG remote controller, the keys can be arranged in two rows or columns so as to locate the many keys in a narrow region, or the EPG-only keys or commonly used keys can be provided on an outer portion of the EPG remote controller, and when the user opens the EPG remote controller by rotating the outer portion or by moving the outer portion in the horizontal direction, the user finds that remaining auxiliary keys such as the number keys are installed therein.

In addition, as shown in FIG. 3(f), the EPG remote controller can be simply implemented with an On/Off key, an EPG mode On/Off key, a user select key, a channel switch key and a volume adjust key without the LCD window.

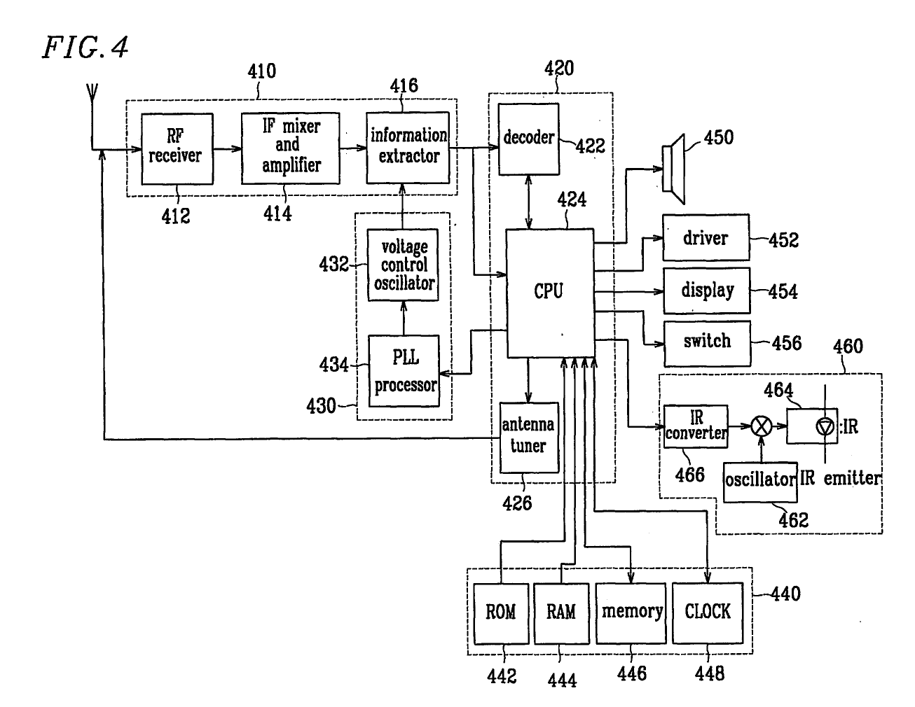

Next, FIG. 4 shows a block diagram of the EPG remote controller according to a preferred embodiment of the present invention using the wireless communication network.

Referring to FIG. 4, the EPG remote controller comprises a radio frequency (RF) receiving unit 410, a signal processor 420, a frequency adjuster 430, a memory unit 440 for storing program information and CPU procedure information, an infrared ray (IR) unit 460 for changing the broadcasting channels, and input and output units 450 to 456.

The RF receiving unit 410 comprises an RF receiver 412, an intermediate frequency (IF) mixer and amplifier 414, and an information extractor 416. The signal processor 420 comprises a decoder 422, a controller 424 and an antenna tuner 426. The frequency adjuster 430 comprises a voltage control oscillator 432 and a phase-locked loop (PLL) processor 434. The memory unit 440 comprises a read only memory (ROM) 442, a random access memory (RAM) 444, a memory 446 and a clock signal generator 448. The IR unit 460 comprises an oscillator 462, an IR emitter 464 and an IR converter 466. The input and output units comprises a speaker 450, a driver 452 for supplying the power and generating vibration signals, a display 454 and a switch 456.

As described with reference to FIG. 1, a skilled person can obviously modify the EPG remote controller shown in FIG. 4 so as to receive program information through the FM DARC method or the wireless data network. Therefore, the EPG remote controller using the pager network of FIG. 4 can be modified to fit the FM DARC method, a mobile phone or a PDA with a built-in infrared ray module or a Bluetooth module.

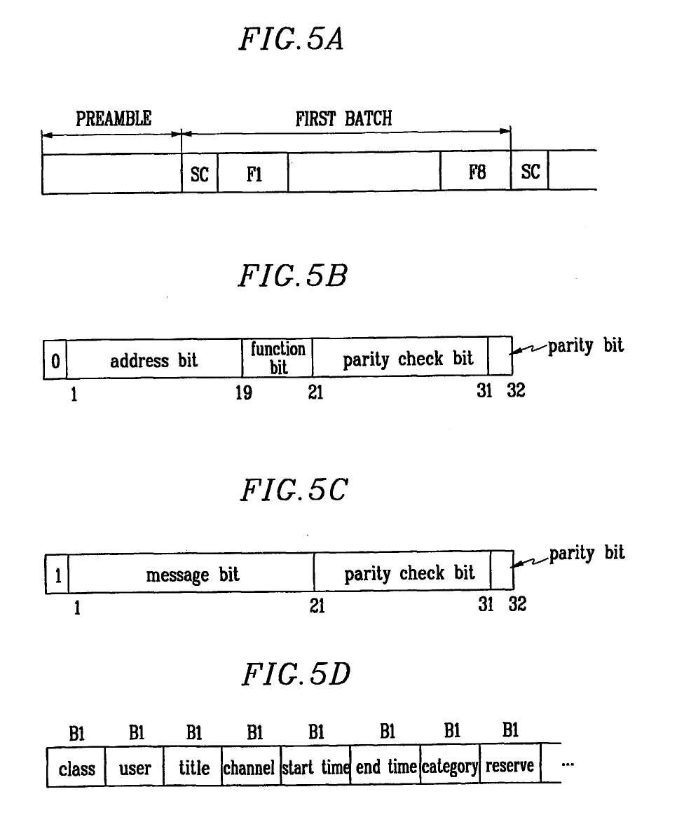

Next, referring to FIG. 5, a preferred embodiment of broadcast program information transmissible through the wireless communication network when managing the EPG service will be described.

FIG. 5 shows signal configurations transmitted to the EPG remote controller according to a preferred embodiment of the present invention, and in particular, representing a case of using the post office code standardization advisory group (POCSAG) type signal format, one paging signal implementation method. In addition, the skilled person can also use the flex method to implement the paging signals.

As shown in FIG. 5(a), the paging signal includes a preamble and a plurality of batches with complete codewords. Each batch may include a single synchronization codeword (SC) at the start of the batch. The 32-bit codewords are transmitted within each batch that includes a single SC and eight frames (each frame has two codewords).

FIG. 5(b) shows an address codeword. The first bit, that is, a flag bit is always set to be zero so as to be distinguished from a message codeword. Second to nineteenth bits, of the 21-bit ID number assigned to a receiver are matched with the eighteen most significant bits (MSBs). Twentieth and twenty-first bits are function bits used for selecting a desired, frame from among the eight frames. Twenty-second to thirty-first bits are parity-check bits, and the last bit is a parity bit.

FIG. 5(c) shows a message codeword. The codeword includes the first flag bit always having the value ‘1,’ twenty message bits, parity check bits and a parity bit. The message always follows the address codeword.

FIG. 5(d) shows an exemplified signal format for representing broadcast program information signal when data signals are message signals. In the broadcast program information, when a day is divided into segments with predetermined uniform time intervals and program information of corresponding time is transmitted for each predetermined time, time information for distinguishing it can be included in the message signal.

Also, when many users use a single EPG remote controller, an ID for distinguishing each user or user information for representing a name is provided to a user, and in this instance, the message signal includes information on the programs selected by the corresponding user, such as broadcast program's title, a broadcasting channel, start-time, end time, an interest field of the corresponding program, and reservation states. The order of FIG. 5(d) can be changed if needed, and other information can be added or deleted.

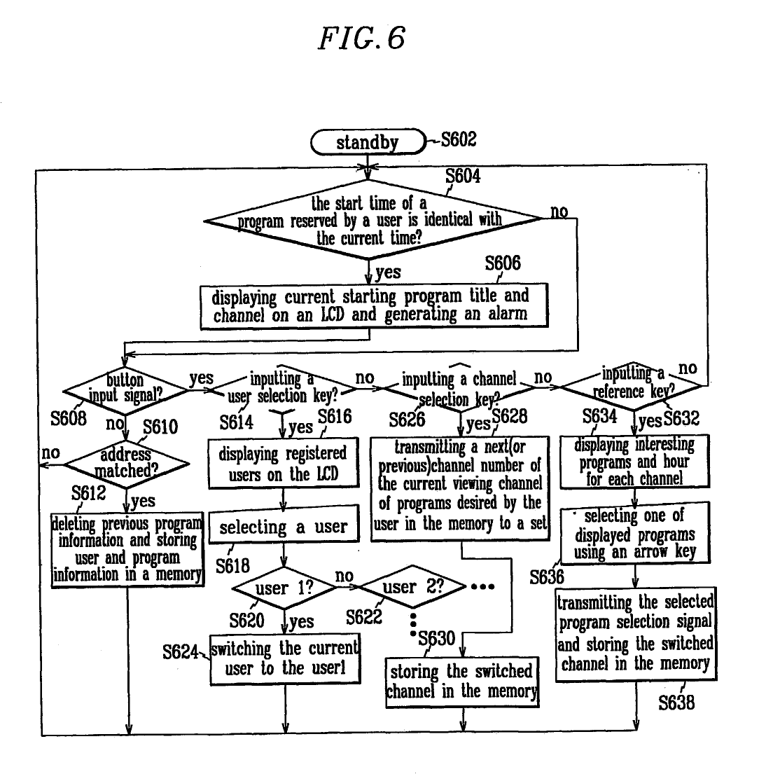

FIG. 6 shows a flowchart of the EPG remote controller according to a preferred embodiment of the present invention.

Referring to FIG. 6, after a normal standby state in step S602, when programs each of which include a reservation signal (which can be optionally omitted) and are stored in a memory are provided, it is checked whether the current time is matched with the start time of the respective programs in step S604, and when a corresponding match is found, information such as the corresponding program's title is displayed on the EPG remote controller and an alarm is generated in step S606. As a different preferred embodiment, control signals for switching channels can be transmitted such that a television channel can be switched to a channel through which the corresponding program may be broadcast.

When a wireless call signal is received, it is checked whether an address number included in the wireless call signal is matched with the address number stored in the ROM 442 in step S610. When they are found to be matched, program information included in the wireless call signal is divided according to users and time, previous information stored in the memory is removed, new information is stored in the memory in step S612, and it goes to the initial standby state. Here, the reason for storing program information in the remote controller differently according to the respective users is in order for different users to use a single remote controller and to separately store the respective users' program information according to their various interests.

When a button input signal is received instead of the wireless call signal in the previous step S608, it is checked to whether the button input signal is used to input a user selection key, a channel selection key or a reference key in steps S614, S626 and S632. In addition, if other key inputs are needed, corresponding functions can be added.

When the user selection key is input, a plurality of the registered users are displayed on the screen of the remote controller in step S616, and it is checked which user is selected in steps S620 and S622. Accordingly, the current user is substituted for the corresponding user, and this substitution is stored in the memory in step S624, and it goes to the initial standby state of the previous step S602. The channel selection key comprises a channel-increasing key and a channel-decreasing key. When the channel-increasing key is selected, a channel selection signal for selecting a channel having a channel number greater than that of the current broadcasting channel among the channels that broadcast the user's interest programs is transmitted in step S628.

When the channel-decreasing key is selected, a channel selection signal for selecting a channel having a channel number less than that of the current broadcasting channel among the channels that broadcast the user's interest programs is transmitted in step S628. The changed channel is stored in the memory to memorize the current channel in step S630, and it goes to the initial standby state of the previous step S602.

When the reference key is input, information on the programs that are now being broadcast or not yet broadcast from among the current user's interest programs is displayed in step S634. When the user selects a program using the arrow key in step S636, a channel selection signal for changing the corresponding program to a channel being or to be broadcast is transmitted, the changed channel is stored in the memory in step S638, and it goes to the initial standby state of the step S602.

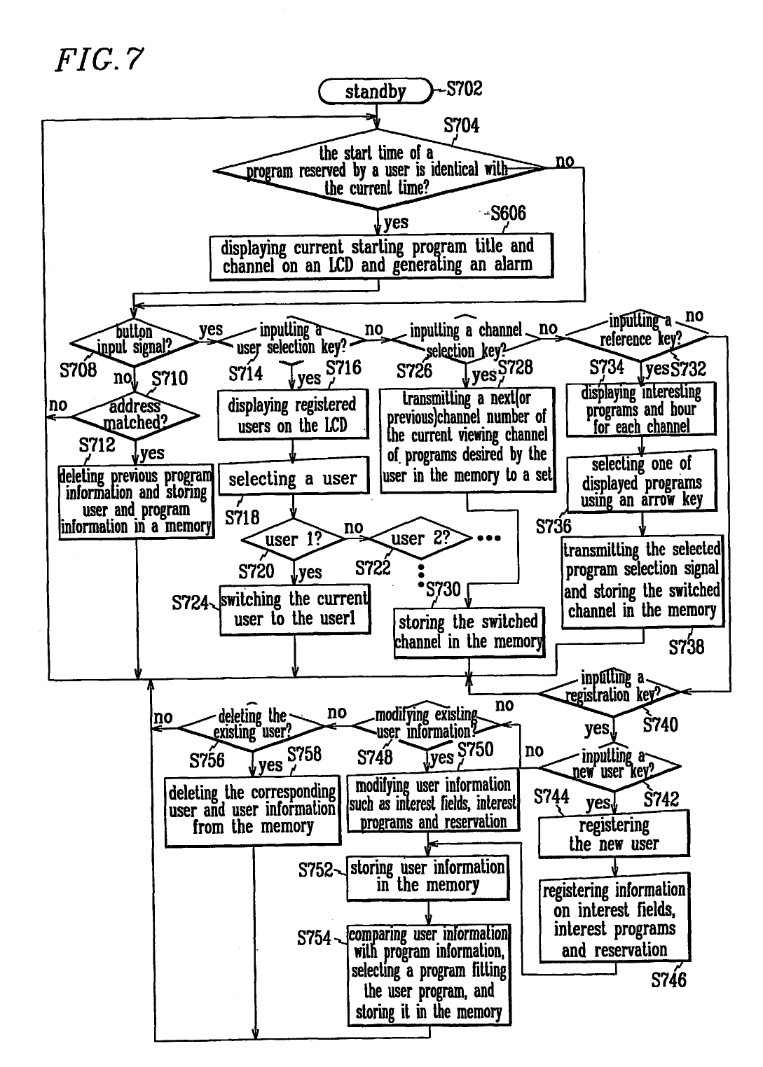

FIG. 7 shows a flowchart for an operation of the EPG remote controller according to a second preferred embodiment of the present invention.

In the second preferred embodiment, information on all programs is transmitted to the remote controller, and a process for selecting interest programs according to user information and the user's interests registration, is executed at the remote controller, and accordingly, differing from the preferred embodiment as shown in FIG. 6, the process of FIG. 2 can be included in the remote controller, and therefore descriptions provided with reference to FIG. 6 will be omitted.

Referring to FIG. 7, when the addresses of the received signals are matched, they are stored in the memory without distinction of the users in step S712. When a registration key is input in step S740, it is determined whether to input a new user in step S742, to modify the existing user information in step S748, or to delete the existing user information in S756. When the step of inputting a new user is determined, an ID is provided to the new user different from the existing user, or the new user is input in step S744.

New interests can be registered, or a specific program is selected from among all the received programs and concurrently reservation states are determined in step S746. Also, the existing user can modify the previously registered interests, specific programs and reservation states and register them in step S750. In this instance, a security step for inputting a password is implemented so as to prevent the user information from being modified or deleted by a third person. The newly registered or modified information is stored in the memory in step S752, the CPU 424 selects and classifies the corresponding interests programs and stores them in the memory in step S754, and it goes to the initial standby state S702. When desiring to delete the existing user in step S756, the corresponding user's ID and user information are deleted from the memory in step S758, and it goes to the initial standby state of the previous step S704.

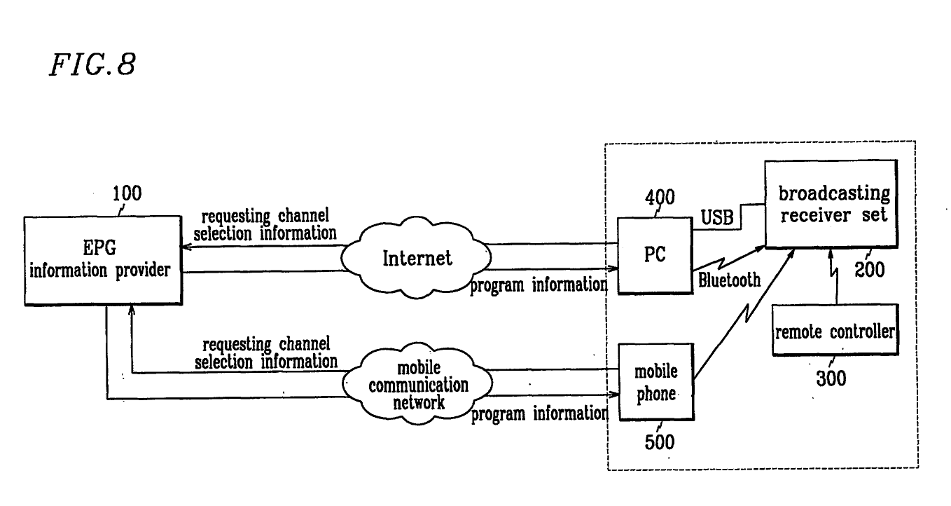

FIG. 8 shows an EPG service-providing system according to a preferred embodiment of the present invention.

Referring to FIG. 8, the EPG service-providing system comprises an EPG information provider 100, a broadcasting receiver set 200, a remote controller 300, an Internet computer 400 and a mobile communication terminal 500. The EPG information provider 100 stores program planning information including at least one broadcasting, channel from among at least one public broadcasting channel, at least one satellite broadcasting channel and at least one cable television channel, and guide information, and outputs program information desired by the user when the computer 400 or the mobile communication terminal 500 requests program information.

The broadcasting receiver set 200 receives television viewing broadcasting signals and outputs them, and receives channel setting broadcast program information together with the television viewing broadcasting signals and stores them, and when channel selection information is requested through the remote controller 300, the broadcasting receiver set 200 displays downloaded channel selection information, and switches to a corresponding channel when a predetermined channel is selected according to the user's manipulation. The broadcasting receiver set 200 can be a television set or a set-top box linked to the television set.

The remote controller 300 cooperated with the broadcasting receiver set 200 provides the broadcasting receiver set 200 with control signals for setting the volume or channels according to the user's key manipulation. In this instance, a plurality of remote controllers can be used for a single broadcasting receiver set 200, or a single remote controller for a single broadcasting receiver set 200.

When a plurality of remote controllers are used for a single broadcasting, receiver set, it is desirable to output a predetermined code value for recognizing a predetermined remote controller when outputting the control signal, and when a remote controller is used for a single broadcasting receiver set, it is desirable to output a predetermined code value for each additionally assigned user when outputting the control signal.

The Internet computer 400 inputs EPG-service-related IDs and personal information including interests of broadcast programs, selects desired broadcast program categories, requests channel selection information from the EPG information provider 100 through an Internet backbone network, downloads program information in response to its reply, and provides downloaded information to the broadcasting receiver set 200 through the universal serial bus (USB) or the Bluetooth method.

The mobile communication terminal 500 inputs EPG-service-related IDs and personal information including interests of broadcast programs, selects desired broadcast program categories, requests channel selection information from the EPG information provider 100 through the mobile communication, network, receives corresponding reply information, and provides it to the broadcasting receiver set 200.

As described above, the EPG information provided to the broadcasting receiver set having the EPG function can be included in the broadcasting signals used when the user watches the broadcasts, or the EPG information can be provided to the broadcasting receiver set in response to a program information request through the user's computer system or mobile communication system via the Internet or mobile communication network.

The corresponding program information can be stored in the memory of the broadcasting receiver set, and used for switching to a corresponding channel in response to a specific user's real-time or reserved channel setting request.

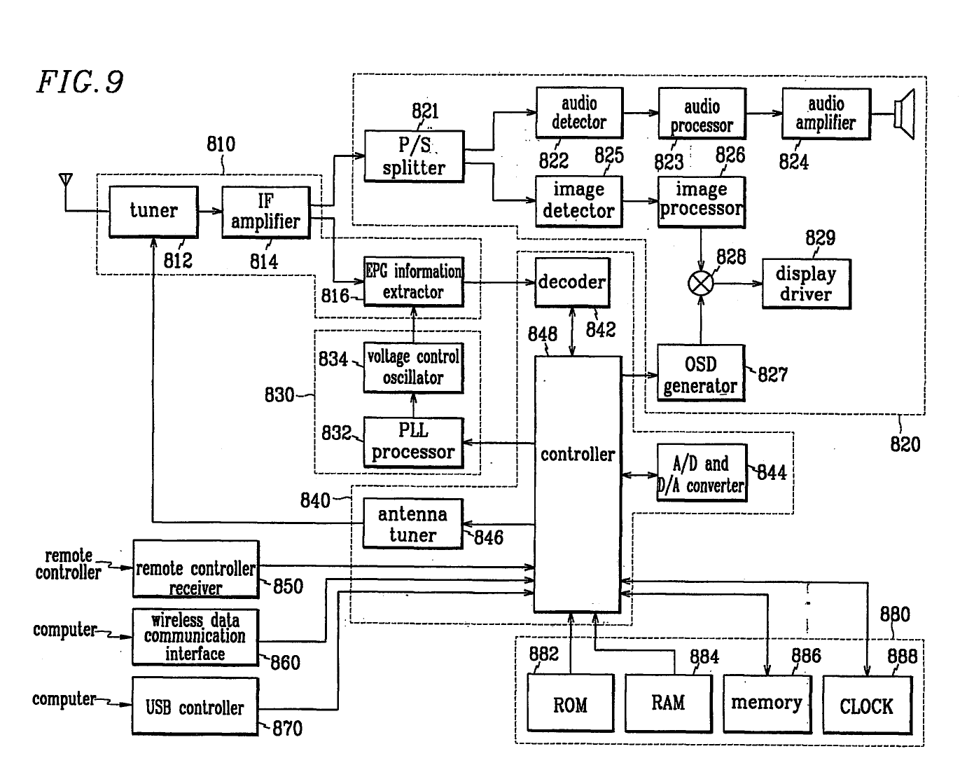

FIG. 9 shows a broadcasting receiver set having an EPG function according to a preferred embodiment of the present invention.

Referring to FIGS. 8 and 9, the broadcasting receiver set having an EPG function comprises an RF receiver 810, a TV signal processor 820, a frequency adjuster 830, a signal processor 840, a remote controller receiver 850, a wireless data communication interface 860, a USB controller 870, and a memory unit 880.

The RF receiver 810 comprises a tuner 812, an IF amplifier 814, and an EPG information extractor 816. The RF receiver 810 receives public broadcasting signals through an antenna, divides them into TV broadcasting signals and program information, and outputs them respectively to the TV signal processor 820 and the signal processor 840.

In detail, the RF receiver 810 receives the public broadcasting signals through an antenna, and the tuner 812 controlled by the signal processor 840 tunes the received broadcasting signals. The IF amplifier 814 comprising a chroma IC or a main IC, amplifies the IF signals output by the tuner 812, and outputs them to the TV signal processor 820 and the EPG information extractor 816.

The EPG information extractor 816 extracts program information included in the public broadcasting signals and transmitted based on the control by the signal controller 840, and outputs it to the signal processor 840.

The TV signal processor 820 comprises a picture/sound (P/S) splitter 821, an audio detector 822, an audio processor 823, an audio amplifier 824, an image detector 825, an image processor 826, an on-screen display (OSD) generator 827, a mixer 828 and a display driver 829, and outputs audio and video signals for watching TV.

In detail, the P/S splitter 821 comprises a surface acoustic wave (SAW) filter, and divides the IF signals divided by the IF amplifier 814 into audio IF and image IF signals, and outputs them respectively to the audio detector 822 and the image detector 825.

The audio detector 822 detects audio signals from the audio IF, and the audio processor 823 performs audio processing such as base, treble and volume on the detected audio signals according to the signal processor's control signals, and the audio amplifier 824 amplifies the processed audio signals to output them to a speaker.

The image detector 825 detects image signals from the image IF. The image processor 826 performs image processing such as color, tint and brightness on the detected image signals according to the signal processor's control signals, and outputs R, G, B and luminance signals Y corresponding to the image signals. The mixer 828 mixes the R, G, B and luminance signals Y with R′, G′, B′ and OSD blanking signals Y′ generated by the OSD generator 827 and outputs mixed signals to the display driver 829, and accordingly, the display displays images together with predetermined OSD pattern data provided by the OSD generator 827.

The frequency adjuster 830 comprises a PLL processor 832 and a voltage control oscillator 834. The frequency adjuster 830 uses the control signals provided by the signal processor 840 to set a predetermined frequency level for extracting program information, and outputs the set frequency level to the EPG information extractor 816.

The signal processor 840 comprises an A/D and D/A converter 844, an antenna tuner 846 and a controller 848. The signal processor 840 outputs control signals for setting the channels of the public broadcasting signals received through the RF receiver 810, outputs predetermined control signals for controlling the extraction operation of program information included in the public broadcasting signals to the frequency adjuster 830, and stores program information provided according to its response in the memory unit 880.

In detail, when a program information setting request is provided via the remote controller receiver 850, the controller 848 outputs an instruction control signal for extracting EPG program information to the frequency adjuster 830, and when program information included in the public broadcasting signals is extracted according to its response and input via the decoder 842, the controller 848 performs a digital conversion on the program information and stores it in the memory unit 880. In this instance, it is preferable that the program information requested by the user is cooperated with the user's interests.

Also, the controller 848 receives user's audio adjustment signals, channel setting request signals and program information storing signals through the remote controller receiver 850, and performs corresponding operations.

Also, the controller 848 receives program information wirelessly transmitted through the wireless data communication interface 860 from an external computer to perform a storing operation, and receives program information input through the USB controller 870 connectable to the external computer to execute a storing operation.

The remote controller receiver 850 converts infrared ray signals provided by an external remote controller into predetermined codes and outputs them to the controller 848. In this instance, the infrared ray signals respectively represent signals responding to operations for the user to request audio adjustments and channel switching.

The wireless data-communication interface 860 installs a Bluetooth chip for enabling short distance (within about 10 meters) wireless data communication and provides the controller 848 with predetermined control signals provided by a wirelessly connected computer.

The USB controller 870 connected through a predetermined wire to a computer provides the controller 848 with the control signals provided by the computer. In this instance, it is desirable that the control signals are cooperated with the user's interests.

The memory unit 880 comprises a ROM 882, a RAM 884, a memory 886 and a clock signal storage unit 888. The memory unit 880 receives program information cooperated with the user's interests and stores it. In this instance, the program information includes the user's interests program information input included in the public broadcasting signals, input through the wireless data communication network, or input through the wire connected to a computer.

As described above, the TV viewers can conveniently select desired channels according to broadcasting program information provided by the EPG, service provider under environments of mixed multi-channels provided

by terrestrial broadcasting, satellite broadcasting, cable broadcasting or wire broadcasting service providers.

According to the present invention, the service providers can provide advertisements to the viewers by target marketing that fits the respective viewers' interests.

Also, according to the present invention, EPG information can be included in the broadcasting signals used for viewers to actually view the broadcasts programs so that they may be directly provided to the broadcasting receiver set having the EPG function, or EPG information can be provided to the broadcasting receiver set through the user's computer system or mobile communication terminal via the Internet or mobile communication network, thereby diversifying the viewers, channel selection environments.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An electronic program guide (EPG) remote controller for wire or wirelessly downloading broadcasting program information including at least one broadcasting channel from among at least one public broadcasting channel, at least one satellite broadcasting channel and at least one cable television channel, storing the same, and selecting a broadcasting channel based on the stored information, comprising:
a memory unit for storing information for selecting broadcasting channels;
a signal sender for outputting signals for changing the broadcasting channels according to a user's manipulation;
a program receiver for wire or wirelessly receiving broadcasting signals, and extracting broadcast program information;
a signal processor for controlling the program receiver's extraction operation of the broadcast program information, decoding the extracted broadcast program information and controlling the decoded broadcast program information to be stored in the memory; and
an input/output unit for inputting/outputting broadcast program signals according to the user's manipulation, and outputting control signals for selecting broadcasting channels to the signal processor.

2. The EPG remote controller of claim 1, wherein the downloaded broadcast program information is one of broadcast program information that fits a user's interests or broadcast program information that is indifferent to the user's interests.

3. The EPG remote controller of claim 2, wherein a request for the downloading is performed by manipulation of the EPG remote controller.

4. The EPG remote controller of claim 1, wherein the downloading of broadcast program information in a wire method is performed using a set-top box capable of receiving satellite broadcasting or digital public broadcasting, a VCR, a network personal computer, or a digital television.

5. The EPG remote controller of claim, 4, wherein the broadcast program information downloaded using the set-top box, VCR, PC and digital, television is transmitted to the EPG remote controller by using one of an IrDA, a Bluetooth or a wire method.

6. The EPG remote controller of claim 4, wherein the selection method of channel signals output by the EPG remote controller is one of an IrDA, a Bluetooth or a wire method.

7. The EPG remote controller of claim 1, wherein the wireless downloading of broadcast program information is performed using one of a pager, a frequency modulation data radio channel (FM DARC), a mobile communication terminal or a personal digital assistant (PDA).

8. The EPG remote controller of claim, 7, wherein the selection method of channel signals output by the EPG remote controller is one of an IrDA, a Bluetooth or a wire method.

9. The EPG remote controller of claim 1, wherein the EPG remote controller is an integrated remote controller unified into one of a pager frequency modulation data radio channel (FM DARC), a mobile communication terminal or a personal digital assistant (PDA).

10. The EPG remote controller of claim 1, wherein the EPG remote controller has a function of monitoring network broadcasting through a personal computer.

11. The EPG remote controller of claim 1, wherein the EPG remote controller is displayed on a display screen of a broadcasting channel as a virtual remote controller so that the EPG remote controller can be implemented as a broadcasting portal site service.

12. An electronic program guide (EPG) service method using an EPG remote controller comprising:
(a) assigning categories of interests broadcast programs from programs including at least one broadcasting channel from among at least one public broadcasting channel, at least one satellite broadcasting channel and at least one cable television channel, and requesting program information for channel selection; and
(b) downloading channel selection information by using information including the assigned program categories, and selecting a channel by using the downloaded channel selection information.

13. The EPG service method of claim 12, wherein in the request for program inform in (a) the method further comprises: inserting at least one advertisement or at least one shopping program according to a user's interests.

14. The EPG service method of claim 12, wherein (b) comprises:
(b-1) checking whether the start time of a program reserved by the user is matched with the current time, and when they are matched, displaying the current starting program title and channel;
(b-2) checking whether a wireless call signal or a button input signal is received when the start time and the current time are not matched in (b-1);
(b-3) checking, when a wireless call signal is received, whether an address number included in the wireless call signal is matched with a stored address number, and when they are matched, updating program information included in the wireless call signal with new information, and going back to (b-1);
(b-4) checking, when a button input signal is input in (b-2), whether it is a user selection key signal, a channel selection key signal or a reference key signal;
(b-5) displaying, when a user selection key signal is input in (b-4), at least one registered user, changing, when a user is selected, the current user with the selected user, storing it in a memory, and going back to (b-1);
(b-6) transmitting to a broadcast program display set a next or previous channel number of a channel currently viewed by the user among programs desired by the user when a channel selection key signal is input in (b-4), storing a changed channel, and going back to (b-1);
(b-7) displaying at least one interests program and time for each channel when a reference key signal is input, transmitting a program selection signal selected when a program is selected, storing the changed channel, and going back to (b-1); and
(b-8) going back to (b-1) when the reference key signal is input in (b-4).

15. The EPG service method of claim 12, wherein (b) comprises:
(b-1) checking whether the start time of a program reserved by the user is matched with the current time, and when they are matched, displaying the current starting program title and channel;
(b-2) checking whether a wireless call signal or a button input signal is received when the start time and the current time are not matched in (b-1);
(b-3) checking, when a wireless call signal is received, whether an address number included in the wireless call signal is matched with a stored address number, and when they are matched, updating program information included in the wireless call signal, with new information, and going back to (b-1);
(b-4) checking, when a button input signal is input in (b-2), whether it is a user selection key signal, a channel selection key signal, a reference key signal or a registration key signal;
(b-5) displaying, when a user selection key signal is input in (b-4), at least one registered user, changing, when a user is selected, the current user with the selected user, storing it in a memory, and going back to (b-1);
(b-6) transmitting to a broadcast program display set a next or previous channel number of a channel currently viewed by the user among programs desired by the user when a channel selection key signal is input in (b-4), storing a changed channel, and going back to (b-1);
(b-7) displaying at least one interests program and time for each channel when a reference key signal is input, transmitting a program selection signal selected when a program is selected, storing the changed channel, and going back to (b-1);
(b-8) checking, when a registration key signal is input in (b-4), whether it is a new user key input signal, a user information modification key signal or a user deletion key signal;
(b-9) registering a new user when it is a new user key input signal in (b-8), registering information including interests, interests programs and reservation, storing user information, comparing the user information and program information, selecting a program matched with the user information, storing the program, and going back to (b-1);
(b-10) modifying the information including interests, interests programs and reservation when it is a user information modification key input signal in (b-8), storing it, comparing the user information with the program information, selecting a program matched with the user information, storing it, and going back to (b-1);
(b-11) deleting corresponding user and user information when it is a user deletion key input signal, and going back to (b-1); and
(b-12) going back to (b-1) when the registration key is not input.

16. An electronic program guide (EPG) service system using an EPG remote controller, comprising:
an EPG information provider for storing program planning information including at least one broadcasting channel of at least one public broadcasting channel, at least one satellite broadcasting channel and at least one cable television channel, and guide information; and
an EPG remote controller for inputting personal information including an EPG remote controller number, an ID and interests of broadcast programs, assigning a desired broadcast program category, requesting channel selection information from the EPG information provider, downloading its response information through a wireless communication network or network backbone network, and manipulating a channel of a program based on the downloaded channel selection information.

17. The EPG service system of claim 16, wherein the EPG service system further comprises a user personal computer for accessing a predetermined EPG service homepage managed by the EPG information provider, inputting personal information including an EPG remote controller number, an ID and interests of broadcast programs, assigning a desired broadcast program category, and requesting channel selection information from the EPG information provider.

18. The EPG service system of claim 16, wherein the downloaded broadcast program information is one of broadcast program information that fits a user's interests or broadcast program information that is indifferent to,. the user's interests.

19. A broadcasting receiver set having an electronic program guide (EPG) comprising:
a broadcasting signal receiver for dividing broadcasting signals for television viewing and broadcast program information for channel setting from broadcasting signals including at least one channel of at least one public television broadcasting channel, at least one satellite broadcasting channel and at least one cable television broadcasting channel, and outputting them;
a television signal processor for dividing audio and video signals from the broadcasting signals for television viewing in response to the manipulation, and outputting them;
a memory unit for storing program information according to at least one user's interests; and:
a signal processor for controlling the broadcasting signal receiver to extract broadcast program information to decode the broadcast program information, controlling the memory unit to store the decoded program information, selecting a broadcasting channel based on the stored program information when a user requests a channel setting, and outputting the same.

20. The broadcasting receiver set of claim 19, wherein the broadcasting receiver set further comprises a remote controller for inputting/outputting broadcast program signals according to the user's key manipulation, and outputting control signals for selecting broadcasting channels to the signal processor.

21. The broadcasting receiver set of claim 19, wherein the signal processor recognizes key manipulation input through the remote controller receiver, checks a predetermined user and outputs control signals for requesting to extract program information corresponding to the predetermined users to the memory.

22. The broadcasting receiver set of claim 19, wherein the broadcasting receiver set further comprises a wireless data communication interface for inputting/outputting broadcast program signals from a wirelessly connected computer system or a mobile communication terminal, and outputting control signals for selecting broadcasting channels to the signal processor.

23. The broadcasting receiver set of claim 19, wherein the broadcasting receiver set further comprises a universal serial bus (USB) controller for inputting/outputting broadcast program signals from a wire-connected computer system, and outputting control signals for selecting broadcasting channels to the signal processor.

24. The broadcasting receiver set of claim 19, wherein the broadcasting receiver set comprises an EPG information extractor for extracting broadcast program, information from the public broadcasting signals, and providing the extracted broadcast program information to the signal processor.

25. The broadcasting receiver set of claim 23, wherein the broadcasting receiver set further comprises a frequency adjuster for setting a predetermined frequency level for extracting broadcast program information, and outputting the set frequency level to the EPG information extractor.

26. The broadcasting receiver set of claim 19, wherein the broadcasting receiver set further comprises an on-screen display (OSD) generator for generating an alarm message before a predetermined time of broadcasting a reserved program, and performing a switching function from the current screen to a reserved channel.
